(19) United States
(12) Patent Application Publication
(10) Pub. No.: US 2022/0215647 A1
(43) Pub. Date: Jul. 7, 2022

(54) IMAGE PROCESSING METHOD AND APPARATUS AND STORAGE MEDIUM

(71) Applicant: SHENZHEN SENSETIME TECHNOLOGY CO., LTD., Shenzhen (CN)

(72) Inventors: Shijie YU, Shenzhen (CN); Dapeng CHEN, Shenzhen (CN); Rui ZHAO, Shenzhen (CN)

(21) Appl. No.: 17/700,881

(22) Filed: Mar. 22, 2022

Related U.S. Application Data
(63) Continuation of application No. PCT/CN2020/099786, filed on Jul. 1, 2020.

(30) Foreign Application Priority Data
Oct. 28, 2019 (CN) 201911035791.0

(51) Int. Cl. G06V 10/74; G06V 10/40; G06V 40/10

(52) U.S. Cl. CPC G06V 10/761; G06V 40/10; G06V 10/40

(57) ABSTRACT

A picture processing method, apparatus and a storage medium are provided. In the method, a first image comprising a first object and a second image comprising a first garment are acquired; a first fused feature vector is obtained by inputting the first image and the second image to a first model, the first fused feature vector represents a fused feature of the first image and the second image; a second fused feature vector is acquired, the second fused feature vector represents a fused feature of a third image and a fourth image, the third image includes a second object, and the fourth image is an image extracted from the third image and comprises a second garment; and it is determined whether the first object and the second object are a same object according to a target similarity between the first fused feature vector and the second fused feature vector.

### CROSS-REFERENCE TO RELATED APPLICATION

This Application is a continuation of International Patent Application No. PCT/CN2020/099786, filed on Jul. 1, 2020, which is based on and claims priority to Chinese Patent Application No. 201911035791.0, filed on Oct. 28, 2019. The disclosures of International Patent Application No. PCT/CN2020/099786 and Chinese Patent Application No. 201911035791.0 are hereby incorporated by reference in their entireties.

### BACKGROUND

Pedestrian re-identification is also referred to as pedestrian re-recognition, which is a technology of determining whether there is a specific pedestrian in an image or a video sequence using a computer vision technique, and may be applied to the fields of intelligent video monitoring, intelligent security protection, etc., so as to for example track suspects and look for missing persons.

In a related pedestrian re-identification method, a garment of a pedestrian, such as a color and style of the garment, is taken as a feature that distinguishes the pedestrian from others to a great extent during feature extraction. Therefore, a related algorithm is unlikely to identify the pedestrian accurately after the garment of the pedestrian is changed.

### SUMMARY

Embodiments of the disclosure relate to the field of image processing, and relate to a method and apparatus for image processing and a computer storage medium.

The embodiment of the disclosure provides a method for image processing. The method includes the following operations. A first image comprising a first object and a second image comprising a first garment are acquired. A first fused feature vector is obtained by inputting the first image and the second image to a first model. The first fused feature vector is configured to represent a fused feature of the first image and the second image. A second fused feature vector is acquired. The second fused feature vector is configured to represent a fused feature of a third image and a fourth image, the third image includes a second object, and the fourth image is an image extracted from the third image and includes a second garment. Whether the first object and the second object are the same object is determined according to a target similarity between the first fused feature vector and the second fused feature vector.

The embodiment of the disclosure further provides an apparatus for image processing. The apparatus includes a processor, a memory, wherein the memory is configured to store program codes; and the processor is configured to call the program codes to perform operations of: acquiring a first image comprising a first object and a second image comprising a first garment; obtaining a first fused feature vector by inputting the first image and the second image to a first model, the first fused feature vector representing a fused feature of the first image and the second image; acquiring a second fused feature vector, the second fused feature vector representing a fused feature of a third image and a fourth image, the third image comprising a second object, and the fourth image being an image extracted from the third image and comprising a second garment; and determining whether the first object and the second object are a same object according to a target similarity between the first fused feature vector and the second fused feature vector.

The embodiment of the disclosure further provides a computer storage medium having stored thereon computer programs including program instructions which, when executed by a processor, causes the processor to perform operations of: acquiring a first image comprising a first object and a second image comprising a first garment; obtaining a first fused feature vector by inputting the first image and the second image to a first model, the first fused feature vector representing a fused feature of the first image and the second image; acquiring a second fused feature vector, the second fused feature vector representing a fused feature of a third image and a fourth image, the third image comprising a second object, and the fourth image being an image extracted from the third image and comprising a second garment; and determining whether the first object and the second object are a same object according to a target similarity between the first fused feature vector and the second fused feature vector.

It is to be understood that the foregoing general description and the following detailed description are only exemplary and explanatory and are not intended to limit the disclosure. According to the following detailed description made to the exemplary embodiments with reference to the drawings, other features and aspects of the disclosure may become clear.

### BRIEF DESCRIPTION OF THE DRAWINGS

In order to describe the technical solutions in the embodiments of the disclosure more clearly, the drawings required to be used for the embodiments are simply introduced below. It is apparent that the drawings described below are merely some embodiments of the disclosure. Other drawings may be further obtained by those of ordinary skill in the art according to these drawings without creative work.

FIG. 1A is a flowchart of a method for image processing according to at least one embodiment of the disclosure.

FIG. 1B is a schematic diagram of an application scenario according to at least one embodiment of the disclosure.

FIG. 2 is a flowchart of another method for image processing according to at least one embodiment of the disclosure.

FIG. 3A is a schematic diagram of a first sample image according to at least one embodiment of the disclosure.

FIG. 3B is a schematic diagram of a third sample image according to at least one embodiment of the disclosure.

FIG. 3C is a schematic diagram of a fourth sample image according to at least one embodiment of the disclosure.

FIG. 4 is a schematic diagram of a training model according to at least one embodiment of the disclosure.

FIG. 5 is a composition structure diagram of an apparatus for image processing according to at least one embodiment of the disclosure.

FIG. 6 is a composition structure diagram of a device for processing an image according to at least one embodiment of the disclosure.

### DETAILED DESCRIPTION

The technical solutions in the embodiments of the disclosure will be clearly and comprehensively described below in combination with the drawings of the embodiments of the disclosure. It is apparent that the described embodiments are not all but merely part of embodiments of the disclosure. All other embodiments obtained by those of ordinary skill in the art based on the embodiments in the disclosure without creative work shall fall within the scope of protection of the disclosure.

The solutions of the embodiments of the disclosure are applied to determination of whether the objects in different images are the same object. A first image (an image to be queried) including a first object and a second image including a first garment are acquired; the first image and the second image are input to a first model to obtain a first fused feature vector; the second fused feature vector of the third image and the fourth image is acquired, the third image includes the second object, and the fourth image is extracted from the third image and includes the second garment; and whether the first object and the second object are the same object is determined according to a target similarity between the first fused feature vector and the second fused feature vector.

The embodiments of the disclosure provide a method for image processing. The method for processing the image may be performed by an apparatus for image processing 50. The apparatus for processing the image may be a User Equipment (UE), a mobile device, a user terminal, a terminal, a cell phone, a cordless phone, a Personal Digital Assistant (PDA), a handheld device, a computing device, a vehicle device, a wearable device, etc. The method may be implemented by a processor through calling computer-readable instructions stored in a memory. Or, the method may be executed by a server.

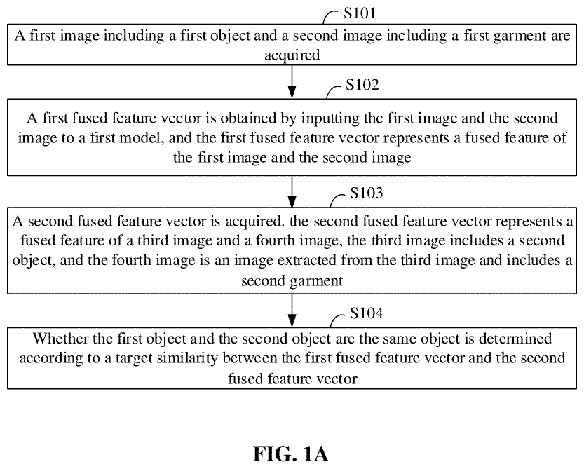

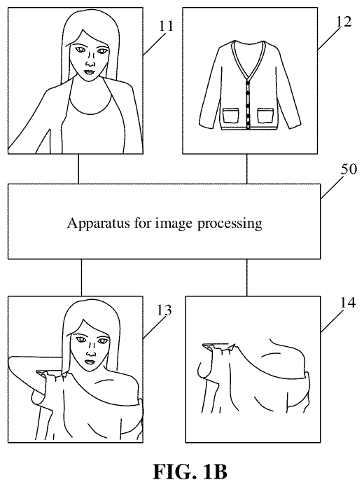

FIG. 1A is a flowchart of a method for image processing according to at least one embodiment of the disclosure. As illustrated in FIG. 1A, the method includes steps S101 to S104.

In S101, a first image including a first object and a second image including a first garment are acquired.

Here, the first image may include the face of the first object and the garment of the first object, and may be a full-length photo, a half-length photo, etc., of the first object. In a possible scenario, for example, the first image is an image of a criminal suspect provided by the police, the first object is the criminal suspect, and the first image may be a full-length photo of the criminal suspect whose face and garment are both uncovered, or a half-length photo including the criminal suspect whose face and garment are both uncovered, etc. Or, when the first object is a photo of missing object (such as a missing child and a missing old person) provided by a relative of the missing object, the first image may be a full-length photo of the missing object whose face and garment are both uncovered, or a half-length photo of the missing object whose face and garment are both uncovered.

The second image may be an image including a garment that the first object may have worn or a garment that the first object is predicted to wear, the second image includes no other object (for example, a pedestrian) but only the garment, and the garment in the second image may be different from the garment in the first image. For example, when the garment that the first object in the first image wears is a blue garment of style 1, the garment in the second image is a garment except the blue garment of style 1, and may be, for example, a red garment of style 1 and blue garment of style 2. It may be understood that the garment in the second image may be the same as the garment in the first image, i.e., the first object is predicted to still wear the garment in the first image.

In S102, a first fused feature vector is obtained by inputting the first image and the second image to a first model. The first fused feature vector is configured to represent a fused feature of the first image and the second image.

Here, the first image and the second image are input to the first model, and the feature extraction is performed on the first image and the second image through the first model, to obtain the first fused feature vector including a fused feature of the first image and the second image. The first fused feature vector may be a low-dimensional feature vector obtained by dimension reduction processing.

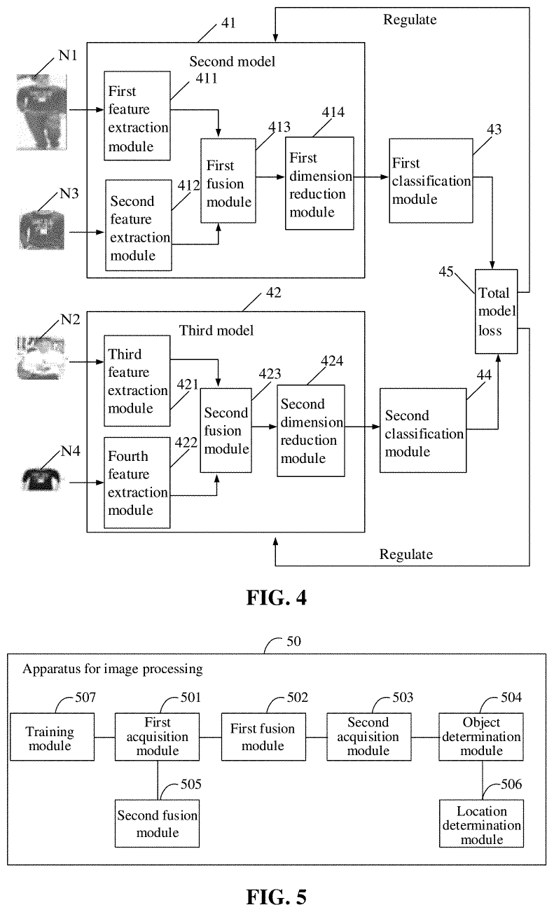

The first model may be a second model 41 or a third model 42 in FIG. 4, and the network structures of the second model and the third model are the same. In some embodiments of the disclosure, the process of performing feature extraction on the first image and the second image through the first model may refer to the process of extracting the fused feature through the second model 41 and the third model 42 in an embodiment corresponding to FIG. 4. For example, when the first model is the second model 41, the feature extraction may be performed on the first image through a first feature extraction module, the feature extraction may be performed on the second image through a second feature extraction module, and then a fused feature vector is obtained through a first fusion module based on a feature extracted through the first feature extraction module and a feature extracted through the second feature extraction module. In some embodiments of the disclosure, the dimension reduction processing is further performed on the fused feature vector through a first dimension reduction module to obtain the first fused feature vector.

It is to be noted that the second model 41 and the third model 42 may be trained in advance to make the first fused feature vector, which is extracted using the trained second model 41 or third model 42, more accurate. For the specific process of training the second model 41 and the third model 42, references may be made to the description of the embodiment corresponding to FIG. 4, and are not described much herein.

In S103, a second fused feature vector is acquired. the second fused feature vector is configured to represent a fused feature of a third image and a fourth image, the third image includes a second object, and the fourth image is an image extracted from the third image and includes a second garment.

Here, the third image may be an image including pedestrians, which is shot by a photographic device erected at a shopping mall, a supermarket, a road junction, a bank, or another position, or may be an image including pedestrians, which is extracted from a monitoring video shot by a monitoring device erected at a shopping mall, a supermarket, a road junction, a bank, or another position and. Multiple third images may be stored in a database, and correspondingly, there may be multiple second fused feature vectors.

In some embodiments of the disclosure, under the condition that the third image is acquired, each third image and a fourth image including the second garment extracted from the third image may be input to the first model, the feature extraction may be performed on the third image and the fourth image through the first model to obtain a second fused feature vector, and the second fused feature vector corresponding to the third image and the fourth image may be correspondingly stored in the database. Furthermore, the second fused feature vector may be acquired from the database, thereby determining the second object in the third image corresponding to the second fused feature vector. For the specific process of performing feature extraction on the third image and the fourth image through the first model, references may be made to the process of performing feature extraction on the first image and the second image through the first model, and is not elaborated herein. One third image corresponds to one second fused feature vector, multiple third images may be stored in the database, and each third image corresponds to the second fused feature vector.

When acquiring the second fused feature vector, each second fused feature vector in the database is acquired. In some embodiments of the disclosure, the first model may be trained in advance to make the second fused feature vector, which is extracted using the trained first model, more accurate. For the specific process of training the first model, references may be made to the description of the embodiment corresponding to FIG. 4, and are not described much herein.

In S104, whether the first object and the second object are the same object is determined according to a target similarity between the first fused feature vector and the second fused feature vector.

Here, whether the first object and the second object are the same object may be determined according to a relationship of the target similarity, which is between the first fused feature vector and the second fused feature vector, and a first threshold. The first threshold may be any numerical value such as 60%, 70%, and 80%. The first threshold is not limited herein. In some embodiments of the disclosure, the target similarity between the first fused feature vector and the second fused feature vector may be calculated using a Siamese network architecture.

In some embodiments of the disclosure, since the database includes multiple second fused feature vectors, it is necessary to calculate a target similarity between the first fused feature vector and each second fused feature vector in the multiple second fused feature vectors in the database, thereby determining whether the first object and the second object corresponding to each second fused feature vector in the database are the same object according to whether the target similarity is greater than the first threshold. Responsive to the target similarity between the first fused feature vector and the second fused feature vector being greater than the first threshold, it is determined that the first object and the second object are the same object. Responsive to the target similarity between the first fused feature vector and the second fused feature vector being less than or equal to the first threshold, it is determined that the first object and the second object are not the same object. In such a manner, whether the multiple third images in the database include an image, where the first object wears the first garment or a garment similar to the first garment, may be determined.

In some embodiments of the disclosure, the target similarity between the first fused feature vector and the second fused feature vector may be calculated. For example, the target similarity between the first fused feature vector and the second fused feature vector is calculated according to a Euclidean distance, a cosine distance, a Manhatton distance, etc. When the first threshold is 80%, and the calculated target similarity is 60%, it is determined that the first object and the second object are not the same object. when the target similarity is 85%, it is determined that the first object and the second object are the same object.

The method for image processing of the embodiments of the disclosure may be applied to scenarios of tracking a suspect, looking for a missing person, etc. FIG. 1B is a schematic diagram of an application scenario according to at least one embodiment of the disclosure. As illustrated in FIG. 1B, when the police looks for a criminal suspect, an image 11 of the criminal suspect is the abovementioned first image, an image 12 including a garment that the criminal suspect wears (or a garment that the suspect criminal is predicted to wear) is the abovementioned second image, a pre-shot image 13 is the abovementioned third image, and an image 14 including a garment which is extracted from the pre-shot image 13 is the abovementioned fourth image. For example, the pre-shot image may be a pedestrian image shot at a shopping mall, a supermarket, a road junction, a bank, or another position, and a pedestrian image extracted from a monitoring video. In some embodiments of the disclosure, the first image, the second image, the third image, and the fourth image may be input to an apparatus 50 for processing an image. Processing may be performed in the apparatus 50 for processing an image based on the methods for processing an image described in the abovementioned embodiments, thereby determining whether the second object in the third image is the first object in the first image, i.e., determining whether the second object is the criminal suspect.

In some embodiments of the disclosure, responsive to the first object and the second object being the same object, an identifier of a terminal device that shoots the third image is acquired. A target geographic location set by the terminal device is determined according to the identifier of the terminal device, and an association relationship between the target geographic location and the first object is established.

Here, the identifier of the terminal device corresponding to the third image is configured to uniquely identify the terminal device that shoots the third image, and may include, for example, an identifier configured to uniquely indicate the terminal device, such as a device factory number of the terminal device that shoots the third image, a location number of the terminal device, a code name of the terminal device, etc. The target geographic location set by the terminal device may include a geographic location of the terminal device that shoots the third image or a geographic location of a terminal device that uploads the third image, and the geographic location may be specific to “Floor F, Unit E, Road D, District C, City B, Province A”. The geographic location of the terminal device that uploads the third image may be an Internet Protocol (IP) address of a corresponding server when the terminal device uploads the third image. Here, when the geographic location of the terminal device that shoots the third image is inconsistent with the geographic location of the terminal device that uploads the third image, the geographic location of the terminal device that shoots the third image may be determined as the target geographic location. The association relationship between the target geographic location and the first object may represent that the first object is in an area including the target geographic location. For example, when the target geographic location is Floor F, Unit E, Road D, District C, City B, Province A, it may indicate that the location of the first object is Floor F, Unit E, Road D, District C, City B, Province A, or the location of the first object is in a certain range of the target geographic location.

In some embodiments of the disclosure, under the condition of determining that the first object and the second object are the same object, the third image including the second object is determined, and the identifier of the terminal device that shoots the third image is acquired, thereby determining the terminal device corresponding to the identifier of the terminal device, further determining the target geographic location set by the terminal device, and determining the location of the first object according to the association relationship between the target geographic location and the first object, so as to track the first object.

For example, for the scenario illustrated in FIG. 1B, under the condition of determining that the first object and the second object are the same object, i.e., under the condition of determining that the second object is the criminal suspect, the geographic location of the photographic device that uploads the third image may be further acquired, thereby determining a movement trajectory of the criminal suspect for the police to track and arrest the criminal suspect.

In some embodiments of the disclosure, a moment when the terminal device shoots the third image may be further determined. The moment when the third image is shot represents that, at the moment, the first object is at the target geographic location where the terminal device is located. In such a case, a location range where the first object may be located at present may be inferred according to a time interval, and then terminal devices in the location range where the first object may be located at present may be searched for. Therefore, the efficiency of locating the first object may be improved.

In the embodiment of the disclosure, the first image including the first object and the second image including the first garment are acquired; the first image and the second image are input to the first model to obtain the first fused feature vector; the second fused feature vector of the third image and the fourth image is acquired, the third image includes the second object, and the fourth image is extracted from the third image and includes the second garment; and whether the first object and the second object are the same object is determined according to the target similarity between the first fused feature vector and the second fused feature vector. When feature extraction is performed on the first object, the garment of the first object is replaced with the first garment that the first object may have worn, i.e., the feature of the garment is weakened when the features of the first object are extracted, and the key is to extract another feature that is more distinctive, such that high identification accuracy may be still achieved after the garment of the first object is changed. Under the condition of determining that the first object and the second object are the same object, the identifier of the terminal device that shoots the third image including the second object is acquired, to determine the geographic location of the terminal device that shoots the third image and further determine a possible location area of the first object, such that the efficiency of locating the first object may be improved.

In some embodiments of the disclosure, in order to make a feature extracted by the model from an image more accurate, before the first image and the second image are input to the model to obtain the first fused feature vector (using the model), the model may be further trained using a large number of sample images and be regulated according to a loss value obtained by training, such that a feature extracted by the trained model from an image is more accurate. Specific steps for training the model are illustrated in FIG. 2. FIG. 2 is a flowchart of another method for image processing according to at least one embodiment of the disclosure. As illustrated in FIG. 2, the method includes steps S201 to S204.

In S201, a first sample image and a second sample image are acquired. Each of the first sample image and the second sample image include a first sample object, and a garment associated with the first sample object in the first sample image is different from a garment associated with the first sample object in the second sample image.

Here, the garment associated with the first sample object in the first sample image is a garment that the first sample object wears in the first sample image, and does not include a garment that the first sample object does not wear in the first sample image, such as a garment in the hand of the first sample object or a garment that is put aside and not worn. The garment of the first sample object in the first sample image is different from the garment of the first sample object in the second sample image. Different garments may include garments in different colors, different styles, or different colors and styles, etc.

In some embodiments of the disclosure, a sample image library may be preset, and the first sample image the second sample image are images in the sample image library. The sample image library includes M sample images, the M sample images are associated with N sample objects, M is equal to or greater than 2N, and M and N are integers equal to or greater than 1. In some embodiments of the disclosure, each sample object in the sample image library corresponds to a serial number, which may be, for example, an Identity Document (ID) number of the sample object or a number configured to uniquely identify the sample object. For example, there are 5,000 sample objects in the sample image library, and the 5,000 sample objects may be numbered as 1 to 5,000. It may be understood that one serial number may correspond to multiple sample images, i.e., the sample image library may include multiple sample images of the sample object numbered as 1 (i.e., images where the sample object numbered as 1 wears different garments), multiple sample images of the sample object numbered as 2, multiple sample images of the sample object numbered as 3, etc. Garments that the sample object wears in multiple sample images corresponding to the same serial number are different, i.e., garments that the sample object wears in each of multiple images corresponding to the same sample object are different. The first sample object may be any sample object in the N sample objects. The first sample image may be any sample image in multiple sample images of the first sample object.

In S202, a third sample image including a first sample garment is extracted from the first sample image. The first sample garment is the garment associated with the first sample object in the first sample image.

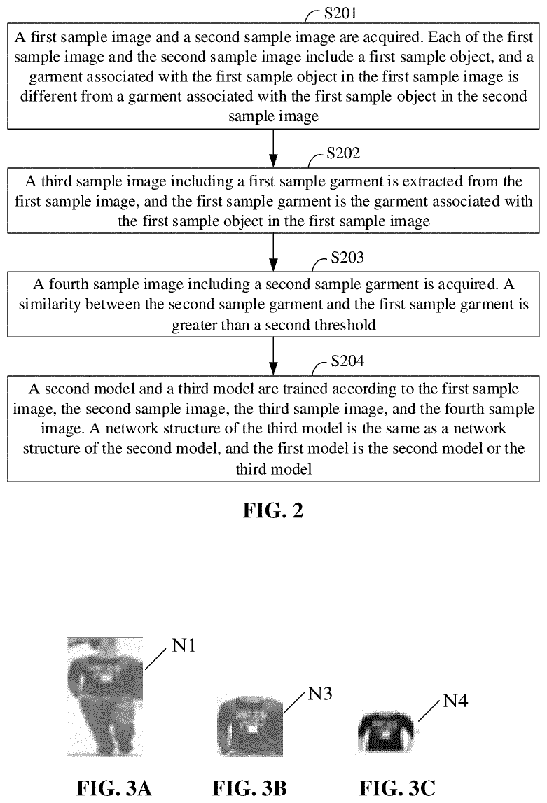

Here, the first sample garment is the garment that the first sample object wears in the first sample image, and the first sample garment may include a coat, trousers, a skirt, a coat plus trousers, etc. The third sample image may be an image which is extracted from the first sample image and includes the first sample garment. FIG. 3A is a schematic diagram of a first sample image according to at least one embodiment of the disclosure. FIG. 3B is a schematic diagram of a third sample image according to at least one embodiment of the disclosure. As illustrated in FIG. 3A and FIG. 3B, the third sample image N3 is an image extracted from the first sample image N1. When the first sample object in the first sample image wears multiple garments, the first sample garment may be the garment corresponding to a maximum ratio in the first sample image. For example, when a ratio of the coat of the first sample object in the first sample image is 30%, and a ratio of the shirt of the first sample object in the first sample image is 10%, the first sample garment is the coat of the first sample object, and the third sample image is an image including the coat of the first sample image.

In S203, a fourth sample image including a second sample garment is acquired. A similarity between the second sample garment and the first sample garment is greater than a second threshold.

Here, the fourth sample image is an image including the second sample garment. It may be understood that the fourth sample image includes no sample object but only the second sample garment. FIG. 3C is a schematic diagram of a fourth sample image according to at least one embodiment of the disclosure. As illustrated in FIG. 3C, the fourth sample image N4 represents an image including the second sample garment.

In some embodiments of the disclosure, the third sample image may be input to the Internet to search for the fourth sample image. For example, the third sample image is input to an APP with an image identification function to search for an image including the second sample garment of which a similarity with the first sample garment in the third sample image is greater than the second threshold. For example, the third sample image may be input to the APP to find multiple images, and the image only including the second sample garment that is most similar to the first sample garment, i.e., the fourth sample image, is selected from the multiple images.

In S204, a second model and a third model are trained according to the first sample image, the second sample image, the third sample image, and the fourth sample image. A network structure of the third model is the same as a network structure of the second model, and the first model is the second model or the third model.

In some embodiments of the disclosure, training the second model and the third model according to the first sample image, the second sample image, the third sample image, and the fourth sample image may include steps S1 to S3.

In S1, the first sample image and the third sample image are input to the second model to obtain a first sample feature vector. the first sample feature vector is configured to represent a fused feature of the first sample image and the third sample image.

The process of inputting the first sample image and the third sample image to the second model to obtain the first sample feature vector are specifically introduced below. References may be made to FIG. 4. FIG. 4 is a schematic diagram of model training according to at least one embodiment of the disclosure. As illustrated in FIG. 4, the following operations are executed.

At first, the first sample image N1 and the third sample image N3 are input to the second model 41, feature extraction is performed on the first sample image N1 through the first feature extraction module 411 in the second model 41 to obtain a first feature matrix, and the feature extraction is performed on the third sample image N3 through the second feature extraction module 412 in the second model 41 to obtain a second feature matrix. Then, fusion processing is performed on the first feature matrix and the second feature matrix through the first fusion module 413 in the second model 41 to obtain a first fused matrix. Next, dimension reduction processing is performed on the first fused matrix through the first dimension reduction module 414 in the second model 41 to obtain the first sample feature vector. Finally, the first sample feature vector is classified through a first classification module 43 to obtain a first probability vector.

In some embodiments of the disclosure, the first feature extraction module 411 and the second feature extraction module 412 may include multiple residual networks, configured to perform the feature extraction on the images. The residual network may include multiple residual blocks, and the residual block consists of convolutional layers. When feature extraction is performed on the images through the residual blocks in the residual networks, the features corresponding to the images obtained by convolving the images through the convolutional layers in the residual networks every time may be compressed, and the parameters and calculations in the model may be reduced. The parameters in the first feature extraction module 411 and the second feature extraction module 412 are different. The first fusion module 413 is configured to fuse the feature, extracted through the first feature extraction module 411, of the first sample image N1 and the feature, extracted through the second feature extraction module 412, of the third sample image N3. For example, the feature, extracted through the first feature extraction module 411, of the first sample image N1 is a 512-dimensional feature matrix, the feature, extracted through the second feature extraction module 412, of the third sample image N3 is a 512-dimensional feature matrix, and the feature of the first sample image N1 and the feature of the third sample image N3 are fused through the first fusion module 413 to obtain a 1,024-dimensional feature matrix. The first dimension reduction module 414 may be a fully connected layer, and is used to reduce the calculations for model training. For example, a matrix obtained by fusing the feature of the first sample image N1 and the feature of the third sample image N3 is a high-dimensional feature matrix, and dimension reduction may be performed on the high-dimensional feature matrix through the first dimension reduction module 414 to obtain a low-dimensional feature matrix. For example, the high-dimensional feature matrix is 1,024-dimensional, and dimension reduction may be performed through the first dimension reduction module to obtain a low 256-dimensional feature matrix. By dimension reduction processing, the calculations for model training may be reduced. The first classification module 43 is configured to classify the first sample feature vector to obtain a probability that the sample object in the first sample image N1 corresponding to the first sample feature vector is each sample object in the N sample objects in the sample image library.

In S2, the second sample image N2 and the fourth sample image N4 are input to the third model 42 to obtain a second sample feature vector. The second sample feature vector is configured to represent a fused feature of the second sample image N2 and the fourth sample image N4.

The process of inputting the second sample image N2 and the fourth sample image N4 to the third model 42 to obtain the second sample feature vector are specifically introduced below. References may be made to FIG. 4. FIG. 4 is a schematic diagram of model training according to at least one embodiment of the disclosure.

At first, the second sample image N2 and the fourth sample image N4 are input to the third model 42, the feature extraction is performed on the second sample image N2 through a third feature extraction module 4211 in the third model 42 to obtain a third feature matrix, and the feature extraction is performed on the fourth sample image N4 through a fourth feature extraction module 422 to obtain a fourth feature matrix. Then, the fusion processing is performed on the third feature matrix and the fourth feature matrix through a second fusion module 423 in the third model 42 to obtain a second fused matrix. Next, the dimension reduction processing is performed on the second fused matrix through a second dimension reduction module 424 in the third model 42 to obtain the second sample feature vector. Finally, the second sample feature vector is classified through a second classification module 44 to obtain a second probability vector.

In some embodiments of the disclosure, the third feature extraction module 421 and the fourth feature extraction module 422 may include multiple residual networks, configured to perform the feature extraction on the images. The residual network may include multiple residual blocks, and the residual block consists of convolutional layers. When the feature extraction is performed on the images through the residual blocks in the residual networks, the features corresponding to the images obtained by convolving the images through the convolutional layers in the residual networks every time may be compressed, and the parameters and calculations in the model may be reduced. The parameters in the third feature extraction module 421 and the fourth feature extraction module 422 are different, the parameters in the third feature extraction module 421 and the first feature extraction module 411 may be the same, and the parameters in the fourth feature extraction module 422 and the second feature extraction module 412 may be the same. The second fusion module 423 is configured to fuse the feature, extracted through the third feature extraction module 421, of the second sample image N2 and the feature, extracted through the fourth feature extraction module 422, of the fourth sample image N4. For example, the feature, extracted through the third feature extraction module 421, of the second sample image N2 is a 512-dimensional feature matrix, the feature, extracted through the fourth feature extraction module 422, of the fourth sample image N4 is a 512-dimensional feature matrix, and the feature of the second sample image N2 and the feature of the fourth sample image N4 are fused through the second fusion module 423 to obtain a 1,024-dimensional feature matrix. The second dimension reduction module 424 may be a fully connected layer, and is used to reduce calculations for model training. For example, the matrix obtained by fusing the feature of the second sample image N2 and the feature of the fourth sample image N4 is a high-dimensional feature matrix, and dimension reduction may be performed on the high-dimensional feature matrix through the second dimension reduction module 424 to obtain a low-dimensional feature matrix. For example, the high-dimensional feature matrix is 1,024-dimensional, and dimension reduction may be performed through the second dimension reduction module 424 to obtain a low 256-dimensional feature matrix. By dimension reduction processing, calculations for model training may be reduced. The second classification module 44 is configured to classify the second sample feature vector to obtain a probability that the sample object in the second sample image N2 corresponding to the second sample feature vector is each sample object in the N sample objects in the sample image library.

In FIG. 4, the third sample image N3 is an image, extracted from the first sample image N1, of garment a of the sample object, the garment in the second sample image N2 is garment b, and garment a and garment b are different garments. The garment in the fourth sample image N4 is garment a, and the sample object in the first sample image N1 and the sample object in the second sample image N2 are the same sample object, such as the sample object numbered as 1. The second sample image N2 in FIG. 4 is a half-length photo including the garment of the sample object, or may be a full-length photo including the garment of the sample object.

In S1 to S2, the second model 41 and the third model 42 may be two models with the same parameters. Under the condition that the second model 41 and the third model 42 are two models with the same parameters, the feature extraction performed on the first sample image N1 and the third sample image N3 through the second model 41 and the feature extraction performed on the second sample image N2 and the fourth sample image N4 through the third model 42 may be implemented at the same time.

In S3, a total model loss 45 is determined according to the first sample feature vector and the second sample feature vector, and the second model 41 and the third model 42 are trained according to the total model loss 45.

A method for determining the total model loss according to the first sample feature vector and the second sample feature vector may be specifically implemented in the following manner

At first, a first probability vector is determined according to the first sample feature vector. The first probability vector is configured to represent probabilities that the first sample object in the first sample image is respective sample objects of the N sample objects.

Here, the first probability vector is determined according to the first sample feature vector, the first probability vector includes N values, and each value is configured to represent the probability that the first sample object in the first sample image is each sample object in the N sample objects. In some embodiments of the disclosure, for example, N is 3,000, the first sample feature vector is a low 256-dimensional vector and is multiplied by a 256*3,000 vector to obtain a 1*3,000 vector, and the 256*3,000 vector includes the features of 3,000 sample objects in the sample image library. Furthermore, the normalization processing is performed on the 1*3,000 vector to obtain the first probability vector, the first probability vector includes 3,000 probabilities, and the 3,000 probabilities are configured to represent the probabilities that the first sample object is each sample object in the 3,000 sample objects.

Then, a second probability vector is determined according to the second sample feature vector. The second probability vector is configured to represent probabilities that the second sample object in the second sample image is respective sample objects of the N sample objects.

Here, the second probability vector is determined according to the second sample feature vector, the second probability vector includes N values, and each value is configured to represent the probability that the second sample object in the second sample image is each sample object in the N sample objects. In some embodiments of the disclosure, for example, N is 3,000, the second sample feature vector is a low 256-dimensional vector and is multiplied by a 256*3,000 vector to obtain a 1*3,000 vector, and the 256*3,000 vector includes the features of 3,000 sample objects in the sample image library. Furthermore, the normalization processing is performed on the 1*3,000 vector to obtain the second probability vector. The second probability vector includes 3,000 probabilities, and the 3,000 probabilities representing the probabilities that the second sample object is each sample object in the 3,000 sample objects.

Finally, the total model loss is determined according to the first probability vector and the second probability vector.

In some embodiments of the disclosure, a model loss of the second model may be determined at first according to the first probability vector, then a model loss of the third model is determined according to the second probability vector, and finally, the total model loss is determined according to the model loss of the second model and the model loss of the third model. As illustrated in FIG. 4, the second model 41 and the third model 42 are regulated through the obtained total model loss 45, i.e., the first feature extraction module 411, first fusion module 413, first dimension reduction module 414, and first classification module 43 in the second model 41, and the second feature extraction module 412, second fusion module 423, second dimension reduction module 424, and second classification module 44 in the third model 42 are regulated.

The maximum probability value is acquired from the first probability vector, and the model loss of the second model is calculated according to the serial number of the sample object corresponding to the maximum probability value, and according to the serial number of the first sample image. The model loss of the second model is configured to represent a difference between the serial number of the sample object corresponding to the maximum probability value and the serial number of the first sample image. When the calculated model loss of the second model is lower, it indicates that the second model is more accurate, and the extracted feature is more distinctive.

The maximum probability value is acquired from the second probability vector, and the model loss of the third model is calculated according to the serial number of the sample object corresponding to the maximum probability value, and according to the serial number of the second sample image. The model loss of the third model is configured to represent a difference between the serial number of the sample object corresponding to the maximum probability value and the serial number of the second sample image. When the calculated model loss of the third model is lower, it indicates that the third model is more accurate, and the extracted feature is more distinctive.

Here, the total model loss may be a sum of the model loss of the second model and the model loss of the third model. When the model loss of the second model and the model loss of the third model are relatively high, the total model loss is relatively high, i.e., the accuracy of the feature vectors, extracted by the models, of the objects is relatively low. Each module (the first feature extraction module 411, the second feature extraction module 412, the first fusion module 413, and the first dimension reduction module 414) in the second model 41 and each module (the third feature extraction module 421, the fourth feature extraction module 422, the second fusion module 423, and the second dimension reduction module 424) in the third model 42 may be regulated using a gradient descent algorithm, so as to make the parameters for model training more accurate and further make the features extracted from the images through the second model 41 and the third model 42 more accurate. That is, the features of the garments in the images are weakened, and the features extracted from the images are mostly features of the objects in the images, i.e., the extracted features are more distinctive, such that the features, extracted through the second model 41 and the third model 42, of the objects in the images are more accurate.

In the embodiment of the disclosure, the process of inputting any sample object (for example, the sample object numbered as 1) in the sample image library to the model for training is described. Inputting any one of sample objects numbered as 2 to N to the model for training may improve the accuracy of extracting the object in the image by the model. For the specific process of inputting the sample objects numbered as 2 to N in the sample image library to the model for training, references may be made to the process of inputting the sample object numbered as 1 to the model for training, and are not described much herein.

In the embodiment of the disclosure, the model is trained using the multiple sample images in the sample image library, each sample image in the sample image library corresponds to a serial number, and the feature extraction is performed on a certain sample image corresponding to the serial number and a garment image in the sample image to obtain a fused feature vector. A similarity between the extracted fused feature vector and a target sample feature vector of the sample image corresponding to the serial number is calculated, whether the model is accurate may be determined according to a calculated result, and under the condition that a loss of the model is relatively high (i.e., the model is inaccurate), the model may be continued to be trained through the other sample images in the sample image library. Since the model is trained using a large number of sample images, the trained model is more accurate, and a feature, extracted through the model, of an object in an image is more accurate.

The method of the embodiments of the disclosure is introduced above, and an apparatus of the embodiments of the disclosure are introduced below.

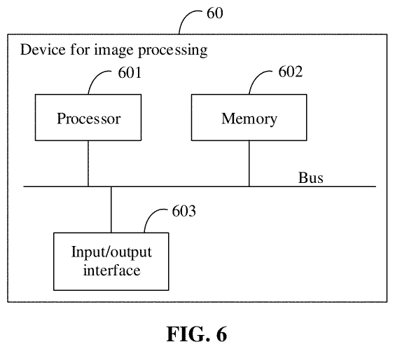

Referring to FIG. 5, FIG. 5 is a composition structure diagram of an apparatus for image processing according to at least one embodiment of the disclosure. The apparatus 50 includes a first acquisition module 501, a first fusion module 502, a second acquisition module 503, and an object determination module 504.

The first acquisition module 501 is configured to acquire a first image including a first object and a second image including a first garment.

Here, the first image may include the face of the first object and a garment of the first object, and may be a full-length photo, half-length photo, etc., of the first object. In a possible scenario, for example, the first image is an image of a criminal suspect provided by the police, the first object is the criminal suspect, and the first image may be a full-length photo of the criminal suspect whose face and garment are both uncovered, or may be a half-length photo including the criminal suspect whose face and garment are both uncovered. Or, when the first object is a photo of missing object (such as a missing child and a missing old person) provided by a relative of the missing object, the first image may be a full-length photo of the missing object whose face and garment are both uncovered, or may be a half-length photo of the missing object whose face and garment are both uncovered. The second image may be an image including a garment that the first object may have worn or a garment that the first object is predicted to wear, the second image includes no other object (for example, a pedestrian) but only the garment, and the garment in the second image may be different from the garment in the first image. For example, when the garment that the first object in the first image wears is a blue garment of style 1, the garment in the second image is a garment except the blue garment of style 1. For example, the garment in the second image may be a red garment of style 1 and blue garment of style 2. It may be understood that the garment in the second image may be the same as the garment in the first image, i.e., the first object is predicted to still wear the garment in the first image.

The first fusion module 502 is configured to input the first image and the second image to a first model to obtain a first fused feature vector. The first fused feature vector is configured to represent a fused feature of the first image and the second image.

Here, the first fusion module 502 inputs the first image and the second image to the first model and performs the feature extraction on the first image and the second image through the first model to obtain the first fused feature vector of a fused feature of the first image and the second image. The first fused feature vector may be a low-dimensional feature vector obtained by dimension reduction processing.

The first model may be a second model 41 or third model 42 in FIG. 4, and the second model 41 and the third model 42 are the same in network structure. During specific implementation, for the process of performing feature extraction on the first image and the second image through the first model, references may be made to the process of extracting the fused feature through the second model 41 and the third model 42 in the embodiment corresponding to FIG. 4. For example, when the first model is the second model 41, the first fusion module 502 may perform the feature extraction on the first image through a first feature extraction module 411, perform the feature extraction on the second image through a second feature extraction module 412 and then obtain a fused feature vector of a feature extracted through the first feature extraction module 411 and a feature extracted through the second feature extraction module 412 through a first fusion module 413. In some embodiments of the disclosure, the dimension reduction processing is further performed on the fused feature vector through a first dimension reduction module 414 to obtain the first fused feature vector.

It is to be noted that the first fusion module 502 may train the second model 41 and the third model 42 in advance to make the first fused feature vector extracted using the trained second model 41 or third model 42 more accurate. For the specific process that the first fusion module 502 trains the second model 41 and the third model 42, references may be made to the description of the embodiment corresponding to FIG. 4, and are not described much herein.

The second acquisition module 503 is configured to acquire a second fused feature vector. The second fused feature vector is configured to represent a fused feature of a third image and a fourth image, the third image includes a second object, and the fourth image is an image extracted from the third image and including a second garment.

Here, the third image may be an image including pedestrians shot by a photographic device erected at a shopping mall, a supermarket, a road junction, a bank, or another position, or may be an image including pedestrians extracted from a monitoring video shot by a monitoring device erected at a shopping mall, a supermarket, a road junction, a bank, or another position. Multiple third images may be stored in a database, and correspondingly, there may be multiple second fused feature vectors.

When the second acquisition module 503 acquires the second fused feature vector, each second fused feature vector in the database may be acquired. During specific implementation, the second acquisition module 503 may train the first model in advance to make the second fused feature vector extracted using the trained first model more accurate. For the specific process of training the first model, references may be made to the description of the embodiment corresponding to FIG. 4, and are not described much herein.

The object determination module 504 is configured to determine whether the first object and the second object are the same object according to a target similarity between the first fused feature vector and the second fused feature vector.

Here, the object determination module 504 may determine whether the first object and the second object are the same object according to a relationship of the target similarity between the first fused feature vector and the second fused feature vector and a first threshold. The first threshold may be any numerical value such as 60%, 70%, and 80%. The first threshold is not limited herein. In some embodiments of the disclosure, the object determination module 504 may calculate the target similarity between the first fused feature vector and the second fused feature vector using a Siamese network architecture.

In some embodiments of the disclosure, since the database includes multiple second fused feature vectors, the object determination module 504 is required to calculate a target similarity between the first fused feature vector and each second fused feature vector in the multiple second fused feature vectors in the database, thereby determining whether the first object and the second object corresponding to each second fused feature vector in the database are the same object according to whether the target similarity is greater than the first threshold. When the target similarity between the first fused feature vector and the second fused feature vector is greater than the first threshold, the object determination module 504 determines that the first object and the second object are the same object. When the target similarity between the first fused feature vector and the second fused feature vector is less than or equal to the first threshold, the object determination module 504 determines that the first object and the second object are not the same object. In such a manner, the object determination module 504 may determine whether the multiple third images in the database include an image where the first object wears the first garment or a garment similar to the first garment.

In some embodiments of the disclosure, the object determination module 504 is configured to, responsive to the target similarity between the first fused feature vector and the second fused feature vector being greater than a first threshold, determine that the first object and the second object are the same object.

In some embodiments of the disclosure, the object determination module 504 may calculate the target similarity between the first fused feature vector and the second fused feature vector. For example, the target similarity between the first fused feature vector and the second fused feature vector is calculated according to a Euclidean distance, a cosine distance, a Manhattan distance, etc. For example, when the first threshold is 80%, and the calculated target similarity is 60%, it is determined that the first object and the second object are not the same object. When the target similarity is 85%, it is determined that the first object and the second object are the same object.

In some embodiments of the disclosure, the second acquisition module 503 is configured to input the third image and the fourth image to the first model to obtain the second fused feature vector.

Under the condition that the second acquisition module 503 acquires the third image, each third image and a fourth image, which is extracted from the third image and includes the second garment, may be input to the first model. The feature extraction may be performed on the third image and the fourth image through the first model to obtain a second fused feature vector, and the second fused feature vector corresponding to the third image and the fourth image may be correspondingly stored in the database. Furthermore, the second fused feature vector may be acquired from the database, thereby determining the second object in the third image corresponding to the second fused feature vector. For the specific process that a second fusion module 505 performs the feature extraction on the third image and the fourth image through the first model, references may be made to the process of performing feature extraction on the first image and the second image through the first model, and are not elaborated herein. One third image corresponds to one second fused feature vector, multiple third images may be stored in the database, and each third image corresponds to the second fused feature vector.

When the second fusion module 505 acquires the second fused feature vector, each second fused feature vector in the database may be acquired. In some embodiments of the disclosure, the second fusion module 505 may train the first model in advance to make the second fused feature vector extracted using the trained first model more accurate. For the specific process of training the first model, references may be made to the description of the embodiment corresponding to FIG. 4, and are not described much herein.

In some embodiments of the disclosure, the apparatus 50 further includes a location determination module 506.

The location determination module 506 is configured to, responsive to the first object and the second object being the same object, acquire an identifier of a terminal device that shoots the third image.

Here, the identifier of the terminal device corresponding to the third image is configured to uniquely identify the terminal device that shoots the third image, and may include, for example, an identifier configured to uniquely indicate the terminal device such as a device factory number of the terminal device that shoots the third image, a location number of the terminal device, a code name of the terminal device, etc. The target geographic location set by the terminal device may include a geographic location of the terminal device that shoots the third image or a geographic location of a terminal device that uploads the third image. The geographic location may be specific to “Floor F, Unit E, Road D, District C, City B, Province A”. The geographic location of the terminal device that uploads the third image may be an IP address of a corresponding server when the terminal device uploads the third image. Here, when the geographic location of the terminal device that shoots the third image is inconsistent with the geographic location of the terminal device that uploads the third image, the location determination module 506 may determine the geographic location of the terminal device that shoots the third image as the target geographic location. The association relationship between the target geographic location and the first object may represent that the first object is in an area including the target geographic location. For example, when the target geographic location is Floor F, Unit E, Road D, District C, City B, Province A, it may indicate that a location of the first object is Floor F, Unit E, Road D, District C, City B, Province A.

The location determination module 506 is configured to determine a target geographic location set by the terminal device according to the identifier of the terminal device, and establish an association relationship between the target geographic location and the first object.

In some embodiments of the disclosure, under the condition of determining that the first object and the second object are the same object, the location determination module 506 determines the third image including the second object, and acquires the identifier of the terminal device that shoots the third image, thereby determining the terminal device corresponding to the identifier of the terminal device, further determining the target geographic location set by the terminal device, and determining the location of the first object according to the association relationship between the target geographic location and the first object, so as to track the first object.

In some embodiments of the disclosure, the location determination module 506 may further determine a moment when the terminal device shoots the third image. The moment when the third image is shot represents that the first object is at the target geographic location where the terminal device is located at the moment. In such case, a location range where the first object may be located at present may be inferred according to a time interval, and then terminal devices in the location range where the first object may be located at present may be searched. Therefore, the efficiency of locating the first object may be improved.

In some embodiments of the disclosure, the apparatus 50 further includes a training module 507.

The training module 507 is configured to acquire a first sample image and a second sample image. Each of the first sample image and the second sample image includes a first sample object, and a garment associated with the first sample object in the first sample image is different from a garment associated with the first sample object in the second sample image.

Here, the garment associated with the first sample object in the first sample image is a garment that the first sample object wears in the first sample image, and does not include a garment that the first sample object does not wear in the first sample image, such as a garment in the hand of the first sample object or a garment that is put aside and not worn. The garment of the first sample object in the first sample image is different from the garment of the first sample object in the second sample image. Different garments may include garments in different colors, different styles, or different colors and styles, etc.

The training module 507 is configured to extract a third sample image including a first sample garment from the first sample image. The first sample garment is the garment associated with the first sample object in the first sample image.

Here, the first sample garment is the garment that the first sample object wears in the first sample image, and the first sample garment may include a coat, trousers, a skirt, a coat plus trousers, etc. The third sample image may be an image extracted from the first sample image and including the first sample garment. As illustrated in FIG. 3A and FIG. 3B, the third sample image N3 is an image extracted from the first sample image N1. When the first sample object in the first sample image wears multiple garments, the first sample garment may be the garment corresponding to a maximum ratio in the first sample image. For example, when a ratio of the coat of the first sample object in the first sample image is 30%, and a ratio of the shirt of the first sample object in the first sample image is 10%, the first sample garment is the coat of the first sample object, and the third sample image is an image including the coat of the first sample image.

The training module 507 is configured to acquire a fourth sample image including a second sample garment. A similarity between the second sample garment and the first sample garment is greater than a second threshold.

Here, the fourth sample image is an image including the second sample garment. It may be understood that the fourth sample image includes no sample object but only the second sample garment.

In some embodiments of the disclosure, the training module 507 may input the third sample image to the Internet to search for the fourth sample image. For example, the third sample image is input to an APP with an image identification function to search for an image including the second sample garment of which a similarity with the first sample garment in the third sample image is greater than the second threshold. For example, the training module 507 may input the third sample image to the APP to find multiple images, and select the image only including the second sample garment that is most similar to the first sample garment, i.e., the fourth sample image, from the multiple images.

The training module 507 is configured to train a second model and a third model according to the first sample image, the second sample image, the third sample image, and the fourth sample image. A network structure of the third model is the same as a network structure of the second model, and the first model is the second model or the third model.

In some embodiments of the disclosure, the training module 507 is configured to input the first sample image and the third sample image to the second model to obtain a first sample feature vector. The first sample feature vector is configured to represent a fused feature of the first sample image and the third sample image.

A process of inputting the first sample image and the third sample image to the second model to obtain the first sample feature vector is specifically introduced below. References may be made to FIG. 4. FIG. 4 is a schematic diagram of model training according to at least one embodiment of the disclosure. As illustrated in FIG. 4, the following operations are executed.

At first, the training module 507 inputs the first sample image N1 and the third sample image N3 to the second model 41, performs the feature extraction on the first sample image N1 through the first feature extraction module 411 in the second model 41 to obtain a first feature matrix, and performs the feature extraction on the third sample image N3 through the second feature extraction module 412 in the second model 41 to obtain a second feature matrix. Then, the training module 507 performs the fusion processing on the first feature matrix and the second feature matrix through the first fusion module 413 in the second model 41 to obtain a first fused matrix. Next, the dimension reduction processing is performed on the first fused matrix through the first dimension reduction module 414 in the second model 41 to obtain the first sample feature vector. Finally, the training module 507 classifies the first sample feature vector through a first classification module 43 to obtain a first probability vector.

The training module 507 is configured to input the second sample image N2 and the fourth sample image N4 to the third model 42 to obtain a second sample feature vector. The second sample feature vector is configured to represent a fused feature of the second sample image N2 and the fourth sample image N4.

A process of inputting the second sample image N2 and the fourth sample image N4 to the third model 42 to obtain the second sample feature vector is specifically introduced below. References may be made to FIG. 4. FIG. 4 is a schematic diagram of model training according to at least one embodiment of the disclosure.

At first, the training module 507 inputs the second sample image N2 and the fourth sample image N4 to the third model 42, performs the feature extraction on the second sample image N2 through a third feature extraction module 4211 in the third model 42 to obtain a third feature matrix, and performs the feature extraction on the fourth sample image N4 through a fourth feature extraction module 422 to obtain a fourth feature matrix. Then, the training module 507 performs fusion processing on the third feature matrix and the fourth feature matrix through a second fusion module 423 in the third model 42 to obtain a second fused matrix. Next, the training module 507 performs the dimension reduction processing on the second fused matrix through a second dimension reduction module 424 in the third model 42 to obtain the second sample feature vector. Finally, the training module 507 classifies the second sample feature vector through a second classification module 44 to obtain a second probability vector.

The second model 41 and the third model 42 may be two models with the same parameters. Under the condition that the second model 41 and the third model 42 are two models with the same parameters, the feature extraction performed on the first sample image N1 and the third sample image N3 through the second model 41 and the feature extraction performed on the second sample image N2 and the fourth sample image N4 through the third model 42 may be implemented at the same time.

The training module 507 is configured to determine a total model loss according to the first sample feature vector and the second sample feature vector, and train the second model 41 and the third model 42 according to the total model loss 45.

In some embodiments of the disclosure, the first sample image and the second sample image are images in a sample image library. The sample image library includes M sample images, and the M sample images are associated with N sample objects. M is equal to or greater than 2N, and M and N are integers equal to or greater than 1.

The training module 507 is configured to determine a first probability vector according to the first sample feature vector. The first probability vector is configured to represent probabilities that the first sample object in the first sample image is respective sample objects of the N sample objects.

In some embodiments of the disclosure, the training module 507 may preset a sample image library, and the first sample image and the second sample image are images in the sample image library. The sample image library includes M sample images, and the M sample images are associated with N sample objects. M is equal to or greater than 2N, and M and N are integers equal to or greater than 1. Optionally, each sample object in the sample image library corresponds to a serial number, which may be, for example, an ID number of the sample object or a number configured to uniquely identify the sample object. For example, there are 5,000 sample objects in the sample image library, and the 5,000 sample objects may be numbered as 1 to 5,000. It may be understood that one serial number may correspond to multiple sample images, i.e., the sample image library may include multiple sample images (i.e., images where the sample object numbered as 1 wears different garments) of the sample object numbered as 1, multiple sample images of the sample object numbered as 2, multiple sample images of the sample object numbered as 3, etc. Garments that the sample object wears in multiple sample images corresponding to the same serial number are different, i.e., garments that the sample object wears in each of multiple images corresponding to the same sample object are different. The first sample object may be any sample object in the N sample objects. The first sample image may be any sample image in multiple sample images of the first sample object.

Here, the training module 507 determines the first probability vector according to the first sample feature vector. The first probability vector includes N values, and each value is configured to represent the probability that the first sample object in the first sample image is each sample object in the N sample objects. Optionally, for example, N is 3,000, the first sample feature vector is a low 256-dimensional vector, and the training module 507 multiplies the first sample feature vector by a 256*3,000 vector to obtain a 1*3,000 vector. The 256*3,000 vector includes the features of 3,000 sample objects in the sample image library. Furthermore, the normalization processing is performed on the 1*3,000 vector to obtain the first probability vector. The first probability vector includes 3,000 probabilities, and the 3,000 probabilities are configured to represent probabilities that the first sample object is each sample object in the 3,000 sample objects.

The training module 507 is configured to determine a second probability vector according to the second sample feature vector. The second probability vector is configured to represent probabilities that the second sample object in the second sample image is respective sample objects of the N sample objects.

Here, the training module 507 determines the second probability vector according to the second sample feature vector. The second probability vector includes N values, and each value is configured to represent the probability that the second sample object in the second sample image is each sample object in the N sample objects. Optionally, for example, N is 3,000, the second sample feature vector is a low 256-dimensional vector, and the training module 507 multiplies the second sample feature vector by a 256*3,000 vector to obtain a 1*3,000 vector. The 256*3,000 vector includes the features of 3,000 sample objects in the sample image library. Furthermore, the normalization processing is performed on the 1*3,000 vector to obtain the second probability vector. The second probability vector includes 3,000 probabilities, and the 3,000 probabilities are configured to represent probabilities that the second sample object is each sample object in the 3,000 sample objects.

The training module 507 is configured to determine the total model loss 45 according to the first probability vector and the second probability vector.

The training module 507 regulates the second model 41 and the third model 42 through the obtained total model loss, i.e., the training module 507 regulates the first feature extraction module 411, first fusion module 413, first dimension reduction module 414, and first classification module 43 in the second model 41, and the second feature extraction module 412, second fusion module 423, second dimension reduction module 424, and second classification module 44 in the third model 42.

In some embodiments of the disclosure, the training module 507 is configured to determine a model loss of the second model according to the first probability loss.

The training module 507 acquires a maximum probability value from the first probability vector, and calculates the model loss of the second model 41 according to the serial number of the sample object corresponding to the maximum probability value and the serial number of the first sample image. The model loss of the second model 41 is configured to represent a difference between the serial number of the sample object corresponding to the maximum probability value and the serial number of the first sample image. When the model loss, calculated by the training module 507, of the second model 41 is lower, it indicates that the second model 41 is more accurate, and the extracted feature is more distinctive.

The training module 507 is configured to determine a model loss of the third model 42 according to the second probability loss.

The training module 507 acquires a maximum probability value from the second probability vector, and calculates the model loss of the third model 42 according to the serial number of the sample object corresponding to the maximum probability value and the serial number of the second sample image. The model loss of the third model 42 is configured to represent a difference between the serial number of the sample object corresponding to the maximum probability value and the serial number of the second sample image. When the model loss, calculated by the training module 507, of the third model 42 is lower, it indicates that the third model 42 is more accurate, and the extracted feature is more distinctive.

The training module 507 is configured to determine the total model loss according to the model loss of the second model 41 and the model loss of the third model 42.

Here, the total model loss may be a sum of the model loss of the second model 41 and the model loss of the third model. When the model loss of the second model and the model loss of the third model are relatively high, the total model loss is relatively high, i.e., the accuracy of the feature vectors, extracted by the models, of the objects is relatively low. Each module (the first feature extraction module, the second feature extraction module, the first fusion module, and the first dimension reduction module) in the second model and each module (the third feature extraction module, the fourth feature extraction module, the second fusion module, and the second dimension reduction module) in the third model may be regulated using a gradient descent algorithm to make the parameters for model training more accurate and further make the features extracted from the images through the second and third models more accurate. That is, the features of the garments in the images are weakened, and the features extracted from the images are mostly features of the objects in the images. That is, the extracted features are more distinctive, such that the features, extracted through the second and third models, of the objects in the images are more accurate.

It is to be noted that for the contents unmentioned in the embodiment corresponding to FIG. 5, references may be made to the description of the method embodiment, and are not elaborated herein.

In the embodiment of the disclosure, the first image including the first object and the second image including the first garment are acquired; the first image and the second image are input to the first model to obtain the first fused feature vector; the second fused feature vector of the third image and the fourth image is acquired, the third image includes the second object, and the fourth image is extracted from the third image and includes the second garment; and whether the first object and the second object are the same object is determined according to the target similarity between the first fused feature vector and the second fused feature vector. When feature extraction is performed on the first object, the garment of the first object is replaced with the first garment that the first object may have worn, i.e., the feature of the garment is weakened when the features of the first object are extracted, and the key is to extract another feature that is more distinctive, such that high identification accuracy may be still achieved after the garment of the first object is changed. Under the condition of determining that the first object and the second object are the same object, the identifier of the terminal device that shoots the third image including the second object is acquired, to determine the geographic location of the terminal device that shoots the third image and further determine a possible location area of the first object, such that the efficiency of locating the first object may be improved. The model is trained using multiple sample images in the sample image library, each sample image in the sample image library corresponds to a serial number, the feature extraction is performed on a certain sample image corresponding to the serial number and a garment image in the sample image to obtain a fused feature vector. A similarity between the extracted fused feature vector and a target sample feature vector of the sample image corresponding to the serial number is calculated, whether the model is accurate may be determined according to a calculated result, and under the condition that a loss of the model is relatively high (i.e., the model is inaccurate), the model may be continued to be trained through the other sample images in the sample image library. Since the model is trained using a large number of sample images, the trained model is more accurate, and a feature, extracted through the model, of an object in an image is more accurate.

In the embodiments of the disclosure, the first image including the first object and the second image including the first garment are acquired; the first image and the second image are input to the first model to obtain the first fused feature vector; the second fused feature vector of the third image and the fourth image is acquired, the third image includes the second object, and the fourth image is extracted from the third image and includes the second garment; and whether the first object and the second object are the same object is determined according to the target similarity between the first fused feature vector and the second fused feature vector. When feature extraction is performed on an object to be queried (the first object), the garment of the object to be queried is replaced with the first garment that the object to be queried may have worn, i.e., the feature of the garment is weakened when the features of the object to be queried are extracted, and the key is to extract another feature that is more distinctive, such that high identification accuracy may be still achieved after the garment of the object to be queried is changed.

Referring to FIG. 6, FIG. 6 is a composition structure diagram of a device for processing an image according to at least one embodiment of the disclosure. The device 60 includes a processor 601, a memory 602, and an input/output interface 603. The processor 601 is connected to the memory 602 and the input/output interface 603. For example, the processor 601 may be connected to the memory 602 and the input/output interface 603 through the bus.

The processor 601 is configured to support the device for image processing to execute corresponding functions in any abovementioned method for processing the image. The processor 601 may be a Central Processing Unit (CPU), a Network Processor (NP), a hardware chip, or any combination thereof. The hardware chip may be an Application Specific Integrated Circuit (ASIC), a Programmable Logic Device (PLD), or a combination thereof. The PLD may be a Complex Programmable Logic Device (CPLD), a Field-Programmable Gate Array (FPGA), a Generic Array Logic (GAL), or any combination thereof.

The memory 602 is configured to store program codes, etc. The memory 602 may include a Volatile Memory (VM) such as a Random Access Memory (RAM). The memory 602 may further include a Non-Volatile Memory (NVM) such as a Read-Only Memory (ROM), a flash memory, a Hard Disk Drive (HDD), or a Solid-State Drive (SSD). The memory 602 may further include a combination of the abovementioned types of memories.

The input/output interface 603 is configured to input or output data.

The processor 601 may call the program codes to execute the following operations:

acquiring a first image comprising a first object and a second image comprising a first garment;

obtaining a first fused feature vector by inputting the first image and the second image to a first model, the first fused feature vector representing a fused feature of the first image and the second image;

acquiring a second fused feature vector, the second fused feature vector representing a fused feature of a third image and a fourth image, the third image comprising a second object, and the fourth image being an image extracted from the third image and comprising a second garment; and

determining whether the first object and the second object are the same object according to a target similarity between the first fused feature vector and the second fused feature vector.

It is to be noted that for the implementation of each operation, references may be further made to the corresponding description in the method embodiments. The processor 601 may further cooperate with the input/output interface 603 to execute the other operations in the method embodiments.

The embodiment of the disclosure further provides a computer storage medium having stored thereon computer programs including program instructions which, when executed by a computer, causes the computer to execute the methods in the abovementioned embodiments. The computer may be part of the abovementioned devices for processing an image, for example, the processor 601.

The embodiments of the disclosure further provides a computer program including computer-readable codes which, when executed in a device for processing an image, causes a processor in the device for image processing to execute any method for processing the image.

It is to be understood by those of ordinary skill in the art that all or part of the flows in the methods of the abovementioned embodiments may be completed by instructing related hardware through computer programs, the programs may be stored in a computer-readable storage medium, and when the programs are executed, the flows of the method embodiments may be included. The storage medium may be a magnetic disk, an optical disk, a ROM, a RAM, etc.

The above descriptions are only the preferred embodiments of the disclosure and, of course, not intended to limit the scope of the disclosure. Therefore, equivalent variations made according to the claims of the disclosure also fall within the scope of the disclosure.

### INDUSTRIAL APPLICABILITY

The disclosure provides a method for image processing, an apparatus, a device, a storage medium, and a computer program. The method includes: acquiring a first image comprising a first object and a second image comprising a first garment; obtaining a first fused feature vector by inputting the first image and the second image to a first model, the first fused feature vector representing a fused feature of the first image and the second image; acquiring a second fused feature vector, the second fused feature vector representing a fused feature of a third image and a fourth image, the third image comprising a second object, and the fourth image being an image extracted from the third image and comprising a second garment; and determining whether the first object and the second object are the same object according to a target similarity between the first fused feature vector and the second fused feature vector. According to the technical solution, a feature of an object in an image may be extracted accurately, such that the accuracy of identifying the object in the image is improved.

1. A method for image processing, comprising:
acquiring a first image comprising a first object and a second image comprising a first garment;
obtaining a first fused feature vector by inputting the first image and the second image to a first model, the first fused feature vector representing a fused feature of the first image and the second image;
acquiring a second fused feature vector, the second fused feature vector representing a fused feature of a third image and a fourth image, the third image comprising a second object, and the fourth image being an image extracted from the third image and comprising a second garment; and
determining whether the first object and the second object are a same object according to a target similarity between the first fused feature vector and the second fused feature vector.

2. The method of claim 1, wherein determining whether the first object and the second object are the same object according to the target similarity between the first fused feature vector and the second fused feature vector comprises:
responsive to the target similarity between the first fused feature vector and the second fused feature vector being greater than a first threshold, determining that the first object and the second object are a same object.

3. The method of claim 1, wherein acquiring the second fused feature vector comprises:
obtaining the second fused feature vector by inputting the third image and the fourth image to the first model.

4. The method of claim 1, further comprising:
responsive to the first object and the second object being the same object, acquiring an identifier of a terminal device that shoots the third image; and
determining a target geographic location set by the terminal device according to the identifier of the terminal device, and establishing an association relationship between the target geographic location and the first object.

5. The method of claim 1, wherein before acquiring the first image comprising the first object and the second image comprising the first garment, the method further comprises:
acquiring a first sample image and a second sample image, each of the first sample image and the second sample image comprising a first sample object, and a garment associated with the first sample object in the first sample image being different from a garment associated with the first sample object in the second sample image;
extracting a third sample image comprising a first sample garment from the first sample image, the first sample garment being the garment associated with the first sample object in the first sample image;
acquiring a fourth sample image comprising a second sample garment, a similarity between the second sample garment and the first sample garment being greater than a second threshold; and
training a second model and a third model according to the first sample image, the second sample image, the third sample image, and the fourth sample image, a network structure of the third model being the same as a network structure of the second model, and the first model being the second model or the third model.

6. The method of claim 5, wherein training the second model and the third model according to the first sample image, the second sample image, the third sample image, and the fourth sample image comprises:
obtaining a first sample feature vector by inputting the first sample image and the third sample image to the second model, the first sample feature vector representing a fused feature of the first sample image and the third sample image;
obtaining a second sample feature vector by inputting the second sample image and the fourth sample image to the third model, the second sample feature vector representing a fused feature of the second sample image and the fourth sample image; and
determining a total model loss according to the first sample feature vector and the second sample feature vector, and training the second model and the third model according to the total model loss.

7. The method of claim 6, wherein the first sample image and the second sample image are images in a sample image library, the sample image library comprises M sample images, the M sample images are associated with N sample objects, M is equal to or greater than 2N, and M and N are integers equal to or greater than 1;
determining the total model loss according to the first sample feature vector and the second sample feature vector comprises:
determining a first probability vector according to the first sample feature vector, the first probability vector representing probabilities that the first sample object in the first sample image is respective sample objects of the N sample objects;
determining a second probability vector according to the second sample feature vector, the second probability vector representing probabilities that a second sample object in the second sample image is respective sample objects of the N sample objects; and
determining a total model loss according to the first probability vector and the second probability vector.

8. The method of claim 7, wherein determining the total model loss according to the first probability vector and the second probability vector comprises:
determining a model loss of the second model according to the first probability vector;
determining a model loss of the third model according to the second probability vector; and
determining the total model loss according to the model loss of the second model and the model loss of the third model.

9. An apparatus for image processing, comprising a processor, a memory, wherein the memory is configured to store program codes; and the processor is configured to call the program codes to perform operations of:
acquiring a first image comprising a first object and a second image comprising a first garment;
obtaining a first fused feature vector by inputting the first image and the second image to a first model, the first fused feature vector representing a fused feature of the first image and the second image;
acquiring a second fused feature vector, the second fused feature vector representing a fused feature of a third image and a fourth image, the third image comprising a second object, and the fourth image being an image extracted from the third image and comprising a second garment; and
determining whether the first object and the second object are a same object according to a target similarity between the first fused feature vector and the second fused feature vector.

10. The apparatus of claim 9, wherein the processor is further configured to call the program codes to: responsive to the target similarity between the first fused feature vector and the second fused feature vector being greater than a first threshold, determine that the first object and the second object are the same object.

11. The apparatus of claim 9, wherein the processor is further configured to call the program codes to: obtain the second fused feature vector by inputting the third image and the fourth image to the first model.

12. The apparatus of claim 9, wherein the processor is further configured to call the program codes to: responsive to the first object and the second object being the same object, acquire an identifier of a terminal device that shoots the third image, determine a target geographic location set by the terminal device according to the identifier of the terminal device, and establish an association relationship between the target geographic location and the first object.

13. The apparatus of claim 9, wherein the processor is further configured to call the program codes to:
acquire a first sample image and a second sample image, each of the first sample image and the second sample image comprising a first sample object, and a garment associated with the first sample object in the first sample image being different from a garment associated with the first sample object in the second sample image;
extract a third sample image comprising a first sample garment from the first sample image, the first sample garment being the garment associated with the first sample object in the first sample image;
acquire a fourth sample image comprising a second sample garment, a similarity between the second sample garment and the first sample garment being greater than a second threshold; and
train a second model and a third model according to the first sample image, the second sample image, the third sample image, and the fourth sample image, a network structure of the third model being the same as a network structure of the second model, and the first model being the second model or the third model.

14. The apparatus of claim 13, wherein the processor is further configured to call the program codes to:
obtain a first sample feature vector by inputting the first sample image and the third sample image to the second model, the first sample feature vector representing a fused feature of the first sample image and the third sample image;
obtain a second sample feature vector by inputting the second sample image and the fourth sample image to the third model, the second sample feature vector representing a fused feature of the second sample image and the fourth sample image;
determine a total model loss according to the first sample feature vector and the second sample feature vector; and
train the second model and the third model according to the total model loss.

15. The apparatus of claim 14, wherein the first sample image and the second sample image are images in a sample image library, the sample image library comprises M sample images, the M sample images are associated with N sample objects, M is equal to or greater than 2N, and M and N are integers equal to or greater than 1; and
the processor is further configured to call the program codes to:
determine a first probability vector according to the first sample feature vector, the first probability vector representing probabilities that the first sample object in the first sample image is respective sample objects of the N sample objects;
determine a second probability vector according to the second sample feature vector, the second probability vector representing probabilities that a second sample object in the second sample image is respective sample objects of the N sample objects; and
determine the total model loss according to the first probability vector and the second probability vector.

16. The apparatus of claim 15, wherein the processor is further configured to call the program codes to: determine a model loss of the second model according to the first probability vector; determine a model loss of the third model according to the second probability vector; and determine the total model loss according to the model loss of the second model and the model loss of the third model.

17. A non-transitory computer storage medium having stored thereon a computer program comprising program instructions that, when executed by a processor, cause the processor to perform operations of:
acquiring a first image comprising a first object and a second image comprising a first garment;
obtaining a first fused feature vector by inputting the first image and the second image to a first model, the first fused feature vector representing a fused feature of the first image and the second image;
acquiring a second fused feature vector, the second fused feature vector representing a fused feature of a third image and a fourth image, the third image comprising a second object, and the fourth image being an image extracted from the third image and comprising a second garment; and
determining whether the first object and the second object are a same object according to a target similarity between the first fused feature vector and the second fused feature vector.

18. The non-transitory computer storage medium of claim 17, wherein determining whether the first object and the second object are the same object according to the target similarity between the first fused feature vector and the second fused feature vector comprises:
responsive to the target similarity between the first fused feature vector and the second fused feature vector being greater than a first threshold, determining that the first object and the second object are a same object.

19. The non-transitory computer storage medium of claim 17, wherein acquiring the second fused feature vector comprises:
obtaining the second fused feature vector by inputting the third image and the fourth image to the first model.

20. The non-transitory computer storage medium of claim 17, wherein the processor is further configured to execute the program instructions to perform operations of:
responsive to the first object and the second object being the same object, acquiring an identifier of a terminal device that shoots the third image; and
determining a target geographic location set by the terminal device according to the identifier of the terminal device, and establishing an association relationship between the target geographic location and the first object.
